(19) United States
(12) Patent Application Publication
(10) Pub. No.: US 2007/0249800 A1
(43) Pub. Date: Oct. 25, 2007

(54) Emitting Color Controllable Polymers for Organic Light Emitting Diode Display Based on Partially Conjugated PPV Copolymers

(75) Inventor: Sangyup Song, Miami, FL (US)

Correspondence Address: NEW SPAN OPTO-TECHNOLOGY INC., 9380 SW 72ND STREET, B-180, MIAMI, FL, 33173, US

(73) Assignee: New Span Opto-Technology Inc., Miami, FL (US)

(21) Appl. No.: 11/379,563

(22) Filed: Apr. 20, 2006

(51) Int. Cl. C08G 61/12; C08G 61/02; C08G 77/00; C08G 75/00; C08G 73/00; C08G 67/00

(52) U.S. Cl. 528/86; 528/10

(57) ABSTRACT

We disclose a new concept to realize emitter color control through the control of conjugation length of the partially conjugated poly(phenylenevinylene) (PCPPV) emitter using the conjugation limited atoms in their polymer backbone. Silicon, nitrogen, oxygen and sulfur are used as the conjugation limitation atoms. The emitting color of PCPPV depends on the conjugation length. For example, PCPPV with a short conjugation length can emit blue color. Increasing the conjugation length, the emitting color can change to longer spectral band such as green and red color. This new concept enables the color tuning for the realization of white light emitting polymer without any complicated fabrication process. The white light emitter can be realized via simple mixing of different color PCPPV emitters and can also be realized through random copolymerization of PCPPV with moderated monomer feeding ratios.

### FIELDS OF THE INVENTION

The invention relates to electro-luminescent materials for a backlight of liquid crystal display (LCD) or an organic light emitting diode (OLED) display, and more particularly, to polymeric light emitting materials that can emit red, green, blue, and white light and other colors according to their chemical structures and conjugation length.

### BACKGROUND OF THE INVENTION

There are three technical challenges in the development of light emitting materials for OLED display, namely 1) low cost manufacturing, 2) increasing light emitting efficiency and lifetime at high brightness, and 3) generating bright illumination quality light. Most of existing OLED displays are prepared by using expensive and inefficient vacuum evaporation of organic light emitting materials. The demonstrated best power conversion efficiency for OLED display is on the order of 5-10% at the brightness levels required for lighting. Since OLED lifetime tends to decrease with increasing brightness, more effort is needed to understand and eliminate degradation mechanisms. Currently, one unsolved problem of OLEDs is to realize the true blue light emitting with long lifetime. Given the performance increases seen in the past decade, however, it is not unreasonable to expect that further innovations in device design and development of new light emitting materials will make the OLED lighting goals achievable in the coming decade.

It is an object of the present invention to provide the poly(phenylenevinylene) (PPV) derivatives having special atoms such as silicon, nitrogen, sulfur or oxygen in their polymer backbone for realizing an improved light emitting polymeric materials.

It is another object of this invention to develop new light emitting polymers and realize red, green, blue (R,G,B), white emitting colors and other colors through the control of the conjugation length of the Partially Conjugated PPVs.

Nothing in the prior art provides the benefits attendant with the present invention.

The foregoing has outlined some of the pertinent objects of the present invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF THE INVENTION

For the purpose of summarizing this invention, this invention provides a design and fabrication methodology of new light emitting polymer materials that can meet the demand of high light emitting efficiency, long lifetime, and excellent stability at the required brightness levels.

The general chemical structure of the partially conjugated PPV (PCPPV) is shown in FIG. 1. The emission light color of PCPPV depends on the PPV unit number (m) in the polymer backbone. The PCPPVs having longer PPV units can reveal longer emission wavelength such as red color. The PCPPVs with shorter PPV units can reveal shorter emission wavelength such as blue color. A white emitting OLED is prepared via two easy methods as shown in FIG. 2. The first method is the simple mixing of several PCPPVs each emits different color such as red, green and blue. The second method to realize the white color emitting PCPPV is forming one PCPPV polymer having different emitting units in their backbone.

In particular, large area white-light emitting OLEDs are of particular interest as they may be useful in a wide range of applications including backlight for displays in portable devices. They could compete favorably with conventional lighting technologies in performance and cost. Currently, such white OLEDs have been prepared by both solution and vacuum deposition techniques. So far, the best efficient devices are obtained by vacuum deposition of small molecules. White light emission has been achieved through the complex and tailored fabrication of multilayer devices either by evaporative or spin coating deposition, or by the blending of two blue-light emitters whose interactions give rise to an exciplex state. In all of these existing OLED development cases, the purity of the white light depends on the quality and concentration of various species, and generally is a function of the applied voltage. The voltage dependent light emitting color is not a desirable functionality of existing OLEDs in addition to their costly fabrication disadvantages.

The partially conjugated PPV derivatives we invented can offer the real white light emitting display without using aforementioned methods because we can tune the emitting color of PCPPV through the control of the conjugation length and thus the energy gap of emitting polymer. White light emitting PCPPV based OLED display has many advantages than full color OLED display in terms of lower manufacturing costs through the use of spin coating technology. In other words, it avoids using expensive vacuum evaporation process. Also the realization of full color display through spin coating a white emitting PCPPV material on ITO followed by metal cathode coating and using a passive color filter as shown in FIG. 3 is easier than local realization of full color OLED pixel elements. The well-established TFT-LCD production line can be used without additional investment for the proposed OLED production since the OLED will act like a backlight for colorful display using a low cost color filter. It does not need to pattern the light emitting pixels by photolithography or any other lithography techniques.

The color of the emitted light is determined by the energy gap of the highest-occupied molecular orbital (HOMO) and lowest-unoccupied molecular orbital (LUMO) of the organic semiconducting material in the active region of the OLED. The synthesis of the PCPPVs having a certain energy gap between HOMO and LUMO can facilitate the controlling of emission wavelength. The shorter conjugated PCPPV has a larger energy gap and will have shorter wavelength absorption and can emit blue light. The longer conjugated PCPPV has a smaller energy gap and will have longer wavelength absorption and can emit red light.

In existing OLED reported by others, the emitting color of a well-known PPV emitter depends on their impurities of the polymer backbone. Thesis impurities acted as a conjugation interrupt units of the conjugated PPV polymer backbone, and the energy gap of emitter is determined by the impurities. However, these impurities cannot be controlled because they are generated naturally during the synthetic process so that the emitting color also cannot be controlled.

In our PCPPVs, on the other hand, the partially conjugated atoms such as silicon, oxygen, nitrogen, or sulfur can act as conjugation interrupter or conjugation terminator like the impurity of conventional PPVs. As a result we can effectively control the emitting color through the control of the conjugation length.

Through the simple mixing of the R, G, B emitted PCPPV derivatives (or other color combination) or the synthesis of random PCPPV polymers from various monomer feeding ratio, we can realized the bright white light emitter. The simple mixing of the R, G, B color emitting PCPPVs with proper color ratio can realize the white light emitter. The PCPPV with random copolymer via polymerization of various monomers can be recognized as the collection of R, G, B color emitting units into a single polymer backbone unit with conjugation interrupted atoms.

### BRIEF DESCRIPTION OF THE DRAWINGS

The above and other objects and features of the present invention will become apparent from the following description thereof, when taken in conjunction with the accompanying drawings.

FIG. 1 shows the general chemical structure of PCPPV derivatives and PCPPV random copolymers.

FIG. 2 shows the two different methods to realize the white light emitting PCPPVs according to the present invention.

FIG. 3 is a schematic of OLED display device using white light emitting PCPPV.

FIG. 4 is a table showing monomers having conjugation interrupt atoms.

FIG. 5 is a table showing Wittig type monomers.

FIG. 6 is a table showing Dialdehyde monomers.

FIG. 7 is a table showing polymer mixing ratio.

FIG. 8 is a table showing monomer feeding ratio for random polymerization.

### DETAILED DESCRIPTION

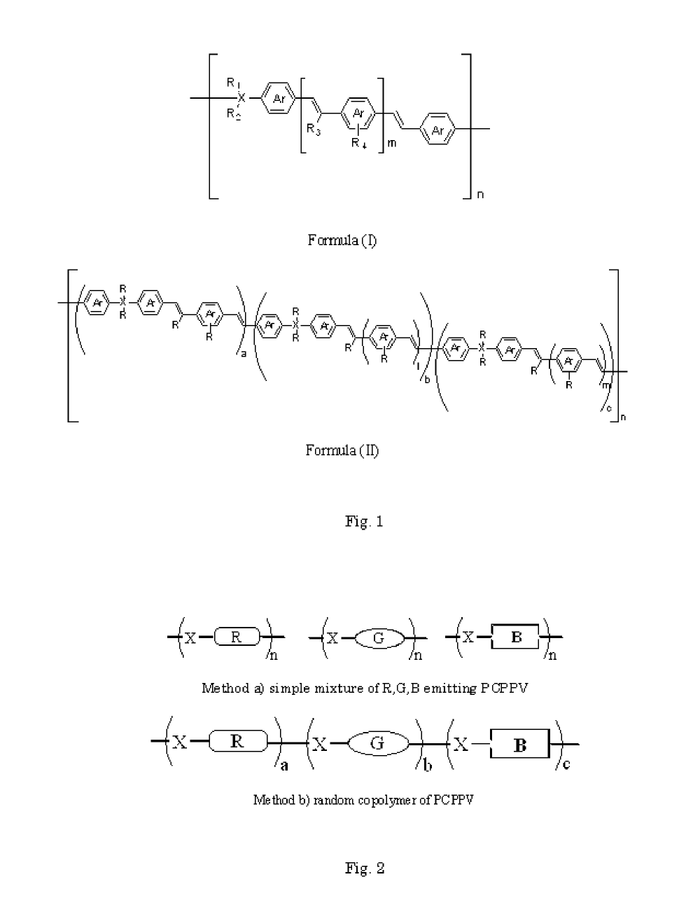

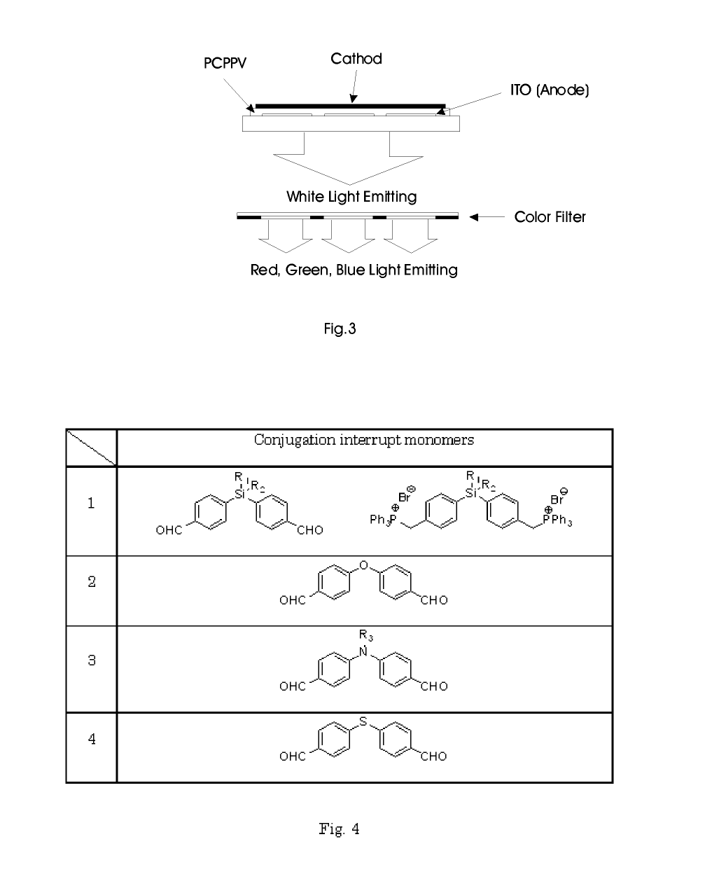

The present invention is on the development of R, G, B and white color light emitting polymer PCPPV derivatives containing silicon, oxygen, nitrogen, or sulfur having general formulation (I) of FIG. 1.

Here, X is an atom that can separate the conjugation such as silicon, nitrogen, oxygen, or sulfur atom. R₁ and R₂ is independently hydrogen atom, aromatic group, branched or straight alkyl chain having from 1 to 10 carbon atoms, substituted or unsubstituted by aryl, substituted or unsubstituted by cycloalkyl, perfluoronated alkyl chain having from 1 to 10 carbon atoms, or nothing. R₃ is an aromatic, CN, branched or straight alkyl chain having from 1 to 10 carbon atoms, substituted or unsubstituted by aryl, substituted or unsubstituted by cycloalkyl, or perfluoronated alkyl chain having from 1 to 10 carbon atoms. R₄ is CN, hydroxy substituted branched or straight alkyl chain having from 1 to 10 carbon atoms, branched or straight alkyl chain having from 1 to 10 carbon atoms, substituted or unsubstituted by aryl, substituted or unsubstituted by cycloalkyl, or perfluoronated alkyl chain having from 1 to 10 carbon atoms. Ar is an aromatic group including heterocyclic groups.

The color of the emitted light is determined by the energy gap of the highest-occupied molecular orbital and the lowest-unoccupied molecular orbital of the organic semiconducting material in the active region of the OLED. The synthesis of the PCPPVs having a certain energy gap between HOMO and LUMO can facilitate the controlling of the emission wavelength. The shorter conjugated PCPPV has larger energy gap and will have a shorter wavelength absorption and can emit blue light. The longer conjugated PCPPV has smaller energy gap and will have a longer wavelength absorption and can emit red light.

In comparison, the emitting colors of existing well-known PPV emitters always depend on their impurities of the polymer backbone. These impurities act as conjugation interrupt units of the conjugated PPV polymer backbone, and the energy gaps of emitters are determined by the impurities. However, these impurities couldn't be controlled because they are generated naturally during the synthetic process so that the emitting color also cannot be controlled.

Our partially conjugated atoms of the PCPPVs such as silicon, oxygen, nitrogen, or sulfur can act as conjugation interrupter or conjugation terminator like the impurity of the conventional PPVs. As a result, we can control the emitting color from the conjugation length control.

Through the simple mixing of the R, G, B (or other color combination) emitting PCPPV derivatives as shown in FIG. 2a) or the synthesis of random PCPPV polymers from various monomer feeding ratio as shown in FIG. 2b), we can realize the bright white light emitter. The simple mixing of the R, G, B color emitting PCPPVs is a easy way to realize the white light emitter. The PCPPV random copolymer via polymerization of various monomers can be recognized as the collection of conjugated repeating units of the formula (I) in FIG. 1 into a single polymer backbone unit with conjugation interrupted atoms. The general chemical structure of the PCPPV random copolymer is shown in formula (II) in FIG. 1.

Here, X is an atom that can separate the conjugation length such as silicon, nitrogen, oxygen, or sulfur atom. R₁ and R₂ is independently hydrogen atom, aromatic group, branched or straight alkyl chain having from 1 to 10 carbon atoms, substituted or unsubstituted by aryl, substituted or unsubstituted by cycloalkyl, perfluoronated alkyl chain having from 1 to 10 carbon atoms, or nothing. R₃ is an aromatic, CN, branched or straight alkyl chain having from 1 to 10 carbon atoms, substituted or unsubstituted by aryl, substituted or unsubstituted by cycloalkyl, or perfluoronated alkyl chain having from 1 to 10 carbon atoms. R₄ is CN, hydroxy substituted branched or straight alkyl chain having from 1 to 10 carbon atoms, branched or straight alkyl chain having from 1 to 10 carbon atoms, substituted or unsubstituted by aryl, substituted or unsubstituted by cycloalkyl, or perfluoronated alkyl chain having from 1 to 10 carbon atoms. Ar is an aromatic group including heterocyclic group. a, b, and c are independent number from 5 to 100, while l is from 2 to 10 and m is from 11 to 100.

Preparation Examples of PCPPVs

Preparation example 1 (m=1, 2, 3)

A mixture 1 mmol of dialdehyde monomer (shown in FIG. 4) and 1 mmol of corresponding wittig reagents (shown in FIG. 5) was dissolved into N,N′-dimethylformaldehyde (DMF) solvent. 2.2 mmol of potassium t-butoxide was added into the reaction flask and the mixture was heated at 80° C. for 48 hrs. After cooling, the reaction mixture was poured into excess large amounts of methyl alcohol, and the precipitated polymer was collected from filtration. The crude polymer was purified with 3 times re-precipitation. The final purified polymer was obtained with 60˜70% yield.

Preparations example 2 (m>4)

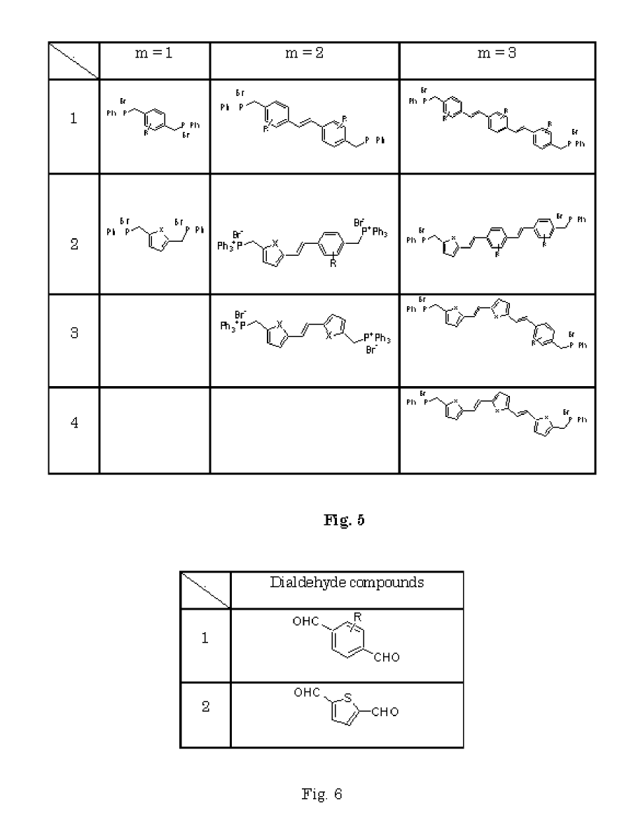

The mixture of 1 mmol of dialdehyde compound (shown in FIG. 6) and 2 mmole of Wittig reagent (m=1 shown in FIG. 5) was dissolved by DMF solution, and 1 mmol of the potassium t-butoxide was added into a flask. The reaction mixture was heated at 80° C. for 4 hrs, and then the oligomer type intermediate was cooled. 1 mmol of dialdehyde compound (FIG. 4) and 1 mole of potassium t-butoxide was added into the reaction flask, and the mixture was reheated at 80° C. for 48 hrs. The polymer was isolated by precipitation from excess amounts of methyl alcohol and collected by filtration. The crude polymer was purified with 3 times re-precipitation. The final purified polymer was obtained with 60˜70% yield.

The Color Tuning Examples for White Light Emitting PCPPV

a) Simple mixing method

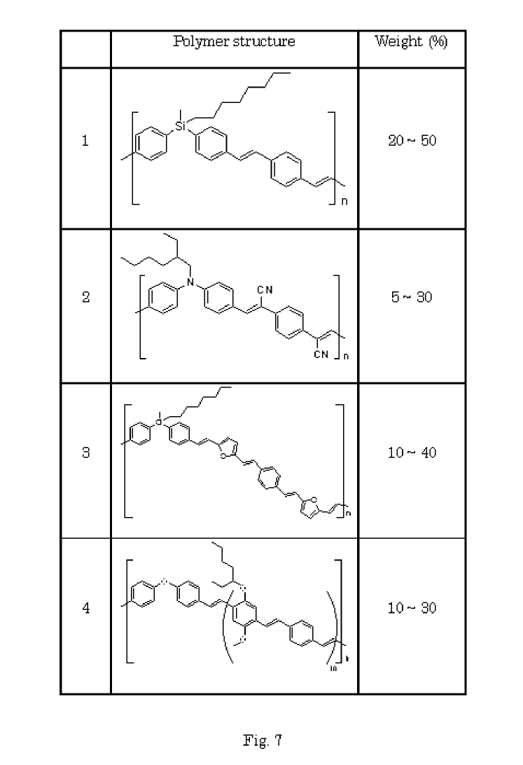

The mixing ratio example for the white light emitter is shown in FIG. 7.

b) White light emitting PCPPV synthesis according to monomer feeding ratio

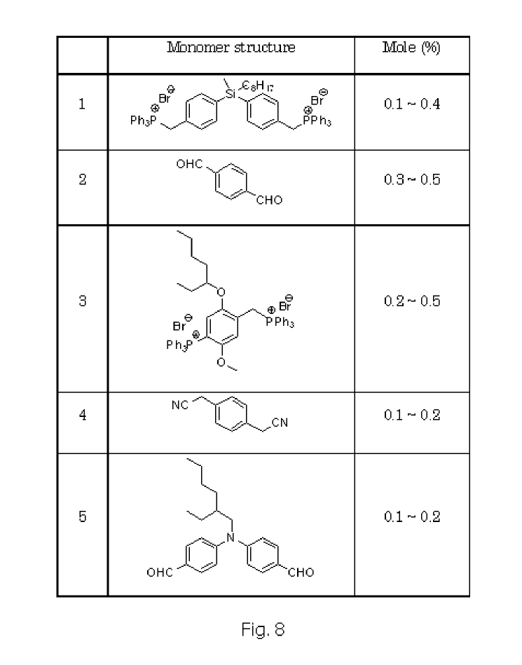

The feeding monomer ratio for the white light emitting PCPPV is shown in FIG. 8 as one example.

Preparation example 3; Random copolymerization

Flame dried 2-necked flask was charged with nitrogen gas. 1 mole of monomer 1 and the slightly excess mole of monomer 2 were placed into the flask and dissolved in DMF solution. Potassium t-butoxide (two molar ratio of monomer 1 was added and heated at 80° C. for 2 hrs. Monomer 3, monomer 4, and slightly excess amount of potassium t-butoxide were added into the mixture and continuously heated with stirring for 2 hrs. Finally, monomer 5 and potassium t-butoxide were added and the reaction mixture was heated for 48 hrs. After cooling the reaction flask, the resulting product was poured into excess amount of methanol and the PCPPV random copolymer was collected by filtration.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described.

What is claimed is:

1. A compound according to formula (I), where X is silicon, nitrogen, oxygen, or sulfur atom.

2. The compound of claim 1, where R₁ and R₂ is independently H, aromatic group, branched or straight alkyl chain having one or more carbon atoms, substituted or unsubstituted aryl, substituted or unsubstituted cycloalkyl, perfluoronated alkyl chain having one or more carbon atoms, or nothing.

3. The compound of claim 1, where R₃ is an aromatic, CN, branched or straight alkyl chain having one or more carbon atoms, substituted or unsubstituted aryl, substituted or unsubstituted cycloalkyl, or perfluoronated alkyl chain having one or more carbon atoms.

4. The compound of claim 1, where R₄ is CN, hydroxy substituted branched or straight alkyl chain having one or more carbon atoms, branched or straight alkyl chain having one or more carbon atoms, substituted or unsubstituted aryl, substituted or unsubstituted cycloalkyl, or perfluoronated alkyl chain having one or more carbon atoms.

5. The compound of claim 1, where Ar comprises benzene, naphthalene, anthracene thophene, furan, pyrrole, pyridine, thiazole, oxazole, pyrimidine, and/or quinoline.

6. The compound of claim 1, wherein n is from about 50 to about 10,000.

7. The compound of claim 1, wherein m is from 0 to 100.

8. A method of color tuning for light emitting polymer, providing simple mixture of several PPV derivatives.

9. A light emitting PCPPV random copolymer according to formula (II), where X is silicon, nitrogen, oxygen, or sulfur atom.

10. The compound of claim 9, where R₁ and R₂ is independently H, aromatic group, branched or straight alkyl chain having one or more carbon atoms, substituted or unsubstituted aryl, substituted or unsubstituted cycloalkyl, perfluoronated alkyl chain having one or more carbon atoms, or nothing.

11. The compound of claim 9, where R₃ is an aromatic, CN, branched or straight alkyl chain having one or more carbon atoms, substituted or unsubstituted aryl, substituted or unsubstituted cycloalkyl, or perfluoronated alkyl chain having one or more carbon atoms.

12. The compound of claim 9, where R₄ is CN, hydroxy substituted branched or straight alkyl chain having one or more carbon atoms, branched or straight alkyl chain having one or more carbon atoms, substituted or unsubstituted aryl, substituted or unsubstituted cycloalkyl, or perfluoronated alkyl chain having one or more carbon atoms.

13. The compound of claim 9, where Ar comprises benzene, naphthalene, anthracene thophene, furan, pyrrole, pyridine, thiazole, oxazole, pyrimidine, and/or quinoline.

14. The compound of claim 9, wherein n is from about 50 to about 10,000.

15. The compound of claim 9, wherein m is from 0 to 3.

16. The compound of claim 9, wherein l is from 4 to 100.

17. The compound of claim 9, wherein a is from 20 to 100, b is from 20 to 100, and c is from 20 to 100.
